(19) United States
(12) Patent Application Publication
(10) Pub. No.: US 2009/0109332 A1
(43) Pub. Date: Apr. 30, 2009

(54) System and method for converting digital image signals

(76) Inventor: Yen-Liang Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/081,332

(22) Filed: Apr. 15, 2008

(30) Foreign Application Priority Data
Oct. 29, 2007 (TW) 96140562

(51) Int. Cl. H04N 7/01

(52) U.S. Cl. 348/441; 348/E07.003

(57) ABSTRACT

A system and a method for converting digital image signals are disclosed. The present invention is used for converting the image signals between different digital interfaces. The preferred embodiment of the invention has a first step of receiving the image signals, and a step of determining the signal format and source based on the detected timing afterwards. The method further goes to display several selective items on a display device, in which a user can select one of the operations. Next, a scan procedure is processed. The selective items include automatic detection, underscan and overscan. Consequently, a specific signal operation operates in response to the parameters recorded in the AVI info frame carried by the HDMI image signals. So as to solve the error display as the signals convert.

### BACKGROUND OF THE INVENTION

1. Field of the Invention

The present invention relates to a system and a method for converting digital image signals, and more particularly to the conversions applied in different digital interfaces that select a scan mode to solve the problem of having wrong displays when signals are converted.

2. Description of Related Art

Signal transmissions can be divided into analog and digital transmissions, and analog signals are gradually replaced by digital signals, particularly for image display devices that require high definition display and resolution. High definition multimedia interface (HDMI) becomes a trend of the consuming market, and HDMI can simultaneously transmit audio and video signals through a same cable, and its application covers the areas of set-top-box, DVD player, TV game player, digital stereo and television, etc.

Although present high-end DVD players generally come with a HDMI port, D-Sub is still the standard interface, which is an analog signal transmission method required for cathode ray tube (CRT) monitors adopting a signal converter to convert digital signals of a display card in a computer system into analog signals before displaying the image signals. During the signal conversion process, the signals are attenuated, and thus the digital visual interface (DVI) specification was developed, and the DVI is a digital transmission method for generating signals from the display card directly by the digital transmission method, and the display device can use the digital receiving method directly. Therefore, there will be no signal attenuation problem, and the display quality can be enhanced greatly.

As to the high definition multimedia interface (HDMI) extensively used in the consuming market, the digital output of a display card of a computer system can be a digital visual interface (DVI) output and the high definition multimedia interface (HDMI) can also be used as a display interface for connecting a display device or an LCD TV display device that supports the HDMI specification.

Referring to FIG. 1 for a schematic view of a transmitter for transmitting multimedia data in accordance with a prior art, a signal converter 100 which is a high definition multimedia interface (HDMI) digital signal converter in this embodiment includes a HDMI transmitter 120, an encoder 40 and a data remapping unit 160. The HDMI transmitter 120 can output digital data of the HDMI specification which is generally a digital audio/video signal encoded by the encoder 140, and the encoded signal is converted into a digital signal of the DVI specification by the data remapping unit 160, and received by a DVI transmitter 180 at another end, and then the digital data of the DVI specification is sent out. On the other hand, the DVI digital signal is received, encoded, mapped and converted into a HDMI digital signal.

From the aforementioned method of converting a DVI digital signal into a HDMI digital signal by a converter, the signal is displayed by a display device of the HDMI specification. For example, the screen of a computer system is converted and displayed on a display device that supports the HDMI specification; or a signal is converted by a HDMI-to-DV converter. Signals of different specifications go through the encoding and mapping processes to convert signals in different specifications by the converter as shown in FIG. 1.

An embodiment of the related technology of transmitting and receive multimedia information are disclosed in U.S. Pat. Publication No. 20070050807, a flow chart of the method and procedure of converting DVI signals into HDMI signals is shown in FIG. 2.

This embodiment shows an 8-byte DVI signal to be converted into a 4-byte HDMI signal and adopts a 10-byte transition-minimized differential signaling error reduction coding-4 (TERC4) encoding/decoding algorithm. The multimedia data of the DVI specification is received (Step S201), such as a computer system (having a DVI receiver) receives a multimedia data generated by the system; and then a processor of the system converts an 8-byte data of the DVI specification into a 10-byte TERC4 code (Step S203), and the decoder decodes the TERC4 code into a 4-byte data of the HDMI specification (Step S205), and finally the decoded HDMI data is received (Step S207). If the aforementioned embodiment is applied to a prior art, the computer system will generate a DVI signal, which is converted into display information of the HDMI specification, and the display information is received by the display device to complete the conversion of image signals.

### SUMMARY OF THE INVENTION

In the prior art, an AVI info frame is frequently filled with a wrong format of a HDMI signal transmitted from a consumer electronic device such as a DVD player, or a DVI digital signal converted into a HDMI signal and transmitted from a computer system, and thus a display device (such as an LCD TV display device) will display a screen according to the wrong information.

To produce an accurate display and provide users the flexibility of selecting a conversion method, the invention discloses a system and a method for converting digital image signals. In addition to the signal processing of executing a general underscan or overscan automatically, the invention also provides a manual selecting method to prevent erroneous display caused by the wrong scan information. In a preferred embodiment, an automatic method or a user manual adjusting method is provided, so that users can select or switch an option of executing a scan such as an underscan option, an overscan option and an auto detection option of a HDMI video through a quick key or a hotkey of a display device controller.

The invention discloses a preferred embodiment of a digital image signal converting system comprising an image signal receiver, a signal analyzer, a timing detector, an image signal processor, a select signal processor, an option display unit and an image signal output unit. The image signal receiver receives an input of external image signals including an image signal of a computer system, and a signal of a general audio/video player, etc. The signal analyzer can analyze the auxiliary video information carried in a HDMI signal. The timing detector determines the timing of the received signals, and then the image signal processor receives the parameters analyzed by the signal analyzer or the source of a signal determined by the timing detector to determine a signal processing measure which can be an underscan or overscan signal processing measure.

The present invention further provides a signal processing measure selected by users through a screen and a display unit for displaying the options of the processing measures. The selected signal processing measure also includes auto detection. If the analyzed information is wrong, a user can manually select an underscan or an overscan, and the image signal output unit will output a converted image signal through the aforementioned system.

The method for converting digital image signals disclosed by the present invention is applied in conversions of different digital interfaces, and a preferred embodiment receives the image signals first, and then determines the format and source of the signals based on the timing, and displays an input/output mode option on a display device, and finally a user decides a processing measure to carry out a desired scan procedure according to the selected processing measure.

The aforementioned options include the options of auto detection, underscan and overscan. If the auto detection option is selected, the system for converting digital image signals will execute the signal processing according to parameters recorded in an information frame of auxiliary video information (AVI). If there is wrong analyzed information, then a user can manually select the underscan or overscan, and finally the converted image signal will be outputted.

To make it easier for our examiner to understand the expected objectives, technical measures and effects of the present invention, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic view of a transmitter for transmitting multimedia data in accordance with a prior art;

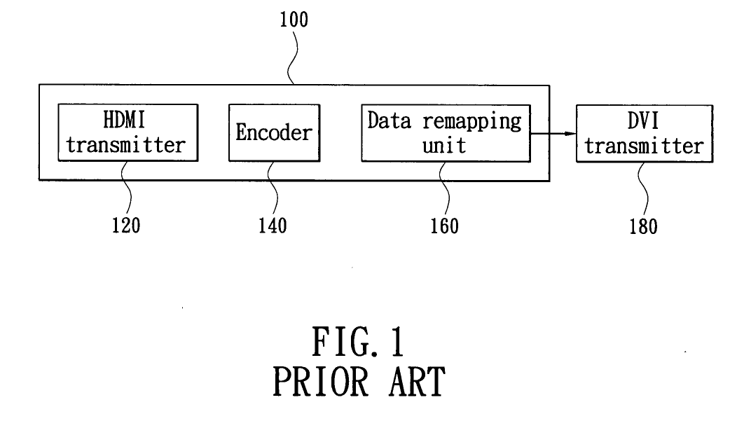

FIG. 2 is a flow chart of converting a DVI signal into a HDMI signal in accordance with a prior art;

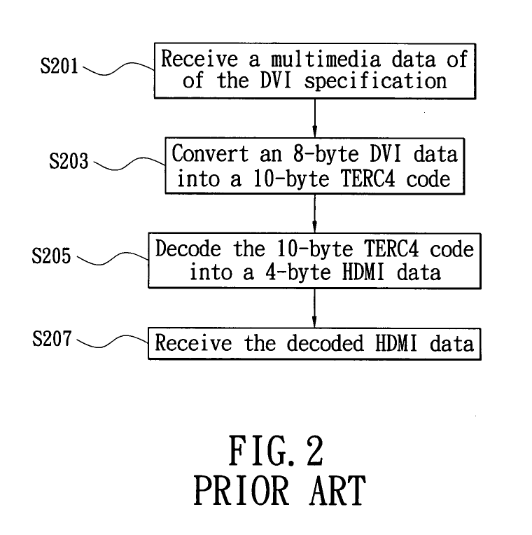

FIG. 3 is a schematic view of a computer system and a display device in accordance with the present invention;

FIG. 4 is a schematic view of executing an option by a remote controller in accordance with the present invention;

FIG. 5 shows an information frame of auxiliary video information (AVI) specification;

FIG. 6 shows the relation between parameters S1, S0 and scan information in the data byte1;

FIG. 7 is a functional block diagram of a system for converting digital image signals in accordance with the present invention;

FIG. 8 is a flow chart of a method for converting digital image signals in accordance with the present invention;

FIG. 9 is a flow chart of a scan processing procedure in accordance with the present invention; and

FIG. 10 is a flow chart of a method for converting digital image signals in accordance with a preferred embodiment of the present invention.

### DETAILED DESCRIPTION OF THE PREFERRED EMBODIMENTS

The present invention is described in details by preferred embodiments together with attached drawings as follows:

In the prior art, display interfaces of different specifications can be converted for displaying signals through an underscan procedure or an overscan procedure, wherein underscan procedure reduces the size of displaying signals and overscan procedure increases the size of the displaying signals so that the signals maybe be properly displayed, however the conversion between the displayed signals may have encoding/decoding errors. In view of the shortcomings of the prior art, the present invention provides a system and a method for converting digital image signals. In addition to the automatic determination and processing for converting signals, the invention also allows users to manually select a processing measure to avoid errors caused by wrong display information.

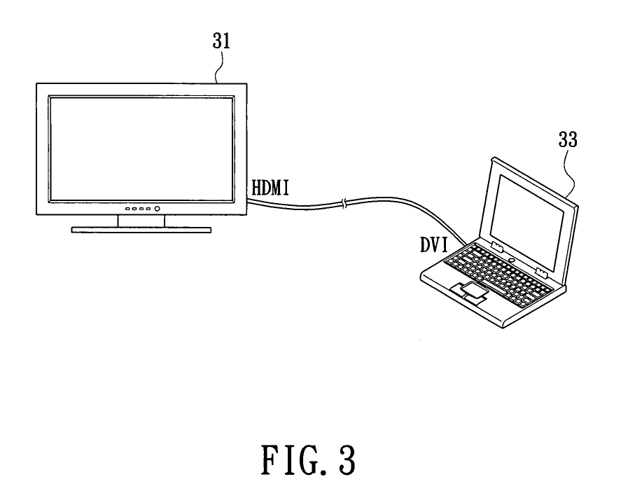

Referring to FIG. 3 for a preferred embodiment of the invention applied to a computer system and a display device, a display card of the computer system 33 comes with a digital output capability and uses the DVI as an image signal output interface. With the DVI-HDMI conversion, a HDMI signal is generated and displayed on a display device 31 that supports the HDMI specification. In this embodiment, a display device 31 (such as a television screen) that supports a general HDMI interface signal is used as a computer screen. A general computer system 33 comes with a traditional analog interface specification, such as a D-sub, or a DVI interface for digital signals. The invention can avoid wrong information displayed on the display device 31 caused during the conversion of DVI signals to HDMI signals. Further, the scope of application also supports a HDMI video device to convert signals that support a HDMI display device and prevents conversion errors.

The wrong scan information produced by the aforementioned conversion causes a wrong display on the display device. For example, different auxiliary information are defined in the specification of HDMI signals, and these auxiliary information are included in the message transmitted from a source device of the image signals, mainly from an auxiliary video information frame (AVI Info Frame) or packaged into a HDMI signal transmitted from a DVD player, or a DVI digital signal transmitted from a computer system and converted into a HDMI signal, wherein a wrong format of the conversion is filled into the AVI info frame frequently, and thus wrong information are displayed on the display device (such as an LCD TV display device) frequently, which includes a portion of the screen being cut off from the display of the computer system, and thus users cannot see a complete screen in order to operate the system correctly.

In addition to the execution of processing the general underscan and overscan signals automatically, the embodiment of the invention also allows users to manually select a signal processing method to prevent wrong displays caused by wrong scan information. The invention aims at a preventive mechanism of the display device to solve the problem of connecting a HDMI or DVI-to-HDMI connector to the display device.

To produce a correct display and provide a flexible solution for users to select or switch a signal processing method, the present invention discloses a system and a method for converting digital image signals and provides an automatic method or a user's manual adjusting method to select or switch an option of executing a signal scan by a quick key or a hot key of a display device controller, and the option includes an underscan, an overscan or an auto detection of a HDMI video.

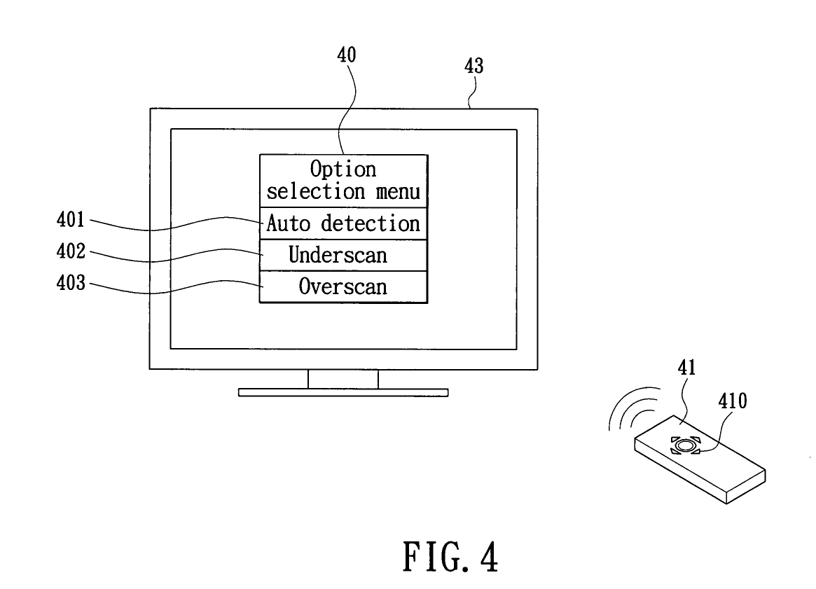

In FIG. 4, users can generate a select signal by pressing an operating key 410 such as a direction key, a quick key or a hotkey on a remote controller 41. After the display device 43 receives the select signal, an option selection menu 40 is shown by an on-screen display (OSD) technology, and the option selection menu 40 includes image processing options such as an auto detection 401, an underscan 402 and an overscan 403 provided for the users to select for the operation.

The auto detection 401 is an option of executing an underscan or overscan processing measure by a processor of a display device 43, after a determination is made, and the determination procedure is based on the aforementioned auxiliary video information (AVI) carried in the signal of the HDMI specification, particularly based on parameters carried in an information frame of the auxiliary video information (AVI). The options of underscan 402 and overscan 403 are options selected manually by users through an operating key 410 of a remote controller 41, so that when there is an error of processing the auto detection signal, a corresponding image processing measure can be taken. Further, each of the foregoing selected signal processing measures can be performed by operating a control panel on the display device 43.

The underscan and overscan processing measures are provided for solving the problem of using an audio/video player of the HDMI specification or connecting a DVI-to-HDMI converter to a display device that supports the HDMI specification. For example, if a computer system connects to a display device that supports a HDMI specification by a digital interface such as DVI, and the display device receives a HDMI signal, then a portion of the transmitted screen display of the computer system may be cut off, and thus users will be unable to see the whole computer screen. To solve this problem, the invention executes an underscan on the display device that supports the HDMI specification to solve the problem of white or black edges, and display a complete screen.

On the other hand, the invention executes an overscan on the display device to prevent errors such as a cut off portion of a screen of the desired displayed image signal transmitted from an audio/video player (such as a DVD player), or an unseen portion at some edges of the visible range of a TV screen when a lower resolution is used for displaying an image of a higher resolution or a general television is used for displaying high resolution images. The overscan captures a vertical blanking interval (VBI) portion (wherein the basic principle of transmitting a television screen is to use the 1^{st} to 22^{nd} lines of a plurality of scan lines of the television, generally referred to as “Vertical Blanking Interval” to attach information) to eliminate blanking noises in order to overcome the cut off portion and fill the images in a full screen.

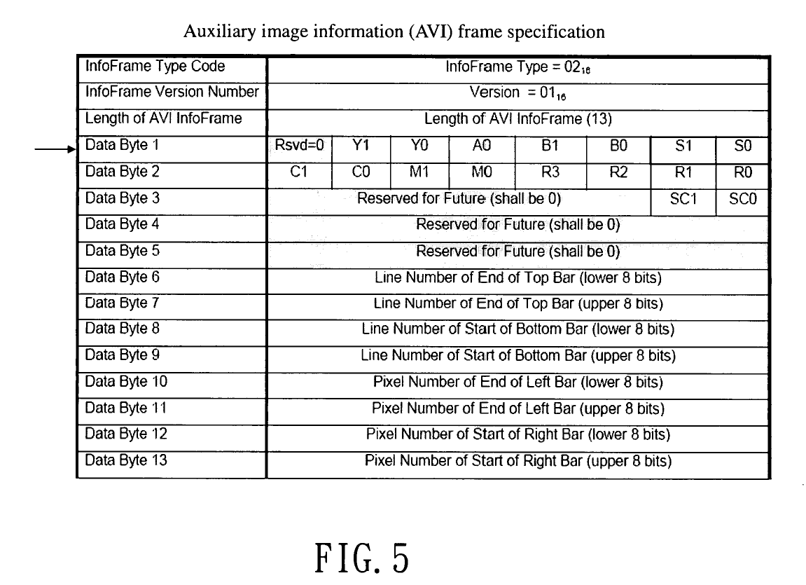

The objective of the present invention is to correctly display an image signal transmitted from an audio/video player of the HDMI specification or a signal converted from DVI to HDMI on a display device that supports the HDMI specification. The invention can automatically execute an underscan or overscan processing measure after a determination takes place, wherein auxiliary information carried in the signal of a HDMI specification as shown in FIG. 5 are parameters recorded in an information frame of auxiliary video information (AVI). The parameter S1 and S0 in the data byte1 (indicated by the arrowhead) represent the source of an image signal of the computer system, or a signal of an audio/video player (such as a TV signal). In addition to the auto detection processing measure, a way of manually selecting the processing measure is taken into consideration in case of having wrong transmitted data and preventing wrong displays caused by wrong scan information. Such arrangement is a preventive mechanism taken at the display device.

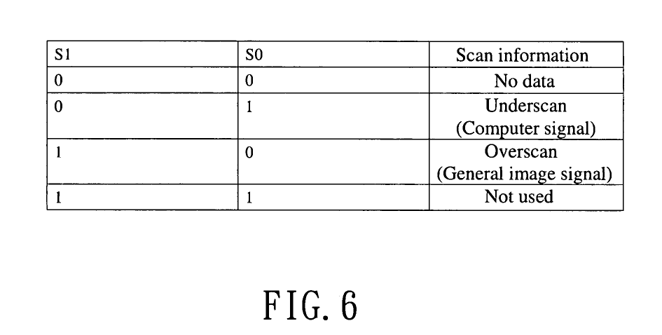

Referring to FIG. 6 for the relation between two bytes of parameters S1, S0 in the data byte 1 and scan information, if the parameter S1 is 0 and the parameter S0 is 0, then it means that no image data is generated; if the parameter S1 is 0 and the parameter S0 is 1, then it means that the image signal is transmitted from a computer system, and the underscan measure will be taken; if the parameter S1 is 1 and the parameter S0 is 0, then it means that the image signal is a general image signal, and the overscan measure will be taken; and if the parameter S1 is 1, and the parameter S0 is 1, then it means no processing measure is defined.

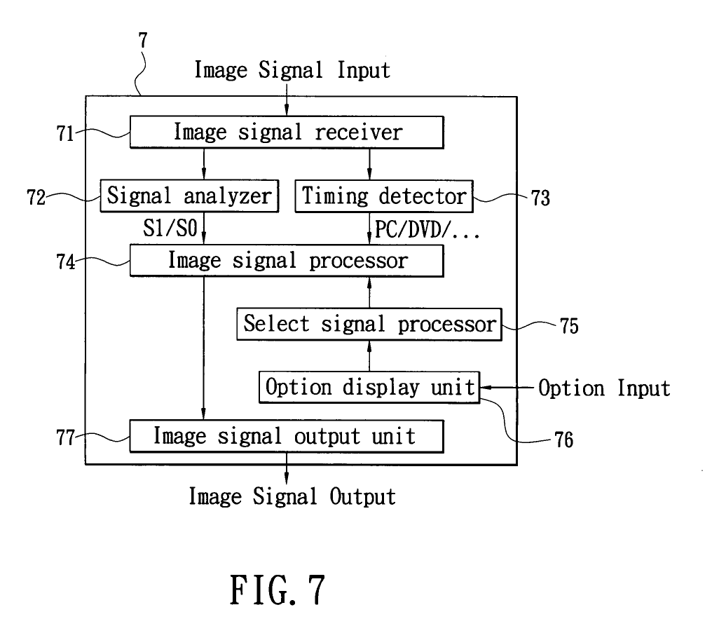

The present invention uses a digital image signal converting system to execute the input/output of different image signals, wherein the system also has the functions such as timing detection, user option input, and scan processing. Refer to FIG. 7 for the schematic functional block diagram of the digital image signal converting system in accordance with the present invention.

In the figure, a digital image signal converting system 7 comprises an image signal receiver 71, a signal analyzer 72, a timing detector 73, an image signal processor 74, a select signal processor 75, an option display unit 76 and an image signal output unit 77. The system 7 receives an input of external image signals including an image signal of a computer system, a signal of a general audio/video player, or any other signal such as a signal inputted from the source of a set-top-box, a TV game player, a digital stereo and a television. The signals are received by an image signal receiver 71, and these signals include the signals inputted through a high definition multimedia interface, or the signals converted from other signals into the high definition multimedia interface (HDMI) specification.

The image signal receiver 71 is electrically coupled to the signal analyzer 72 and the timing detector 73, wherein the signal analyzer 72 can analyze auxiliary video information (AVI) carried by the HDMI signal, such as the parameter recorded in an information frame of the auxiliary video information (AVI) as shown in FIG. 5, particularly the parameters S1 and S0 in a data byte1, and the values of the two parameters determine a processing measure required by the image signal. The timing detector 73 determines the timing of the received signal, and the timing is used for determining whether or not the image signal is a signal transmitted from a computer system in a preferred embodiment. Like the image display card, the image timing of the computer system supports a resolution of 800*600, 1024*768, 1280*1024 or any other higher resolution. The signal analyzer 72 and the timing detector 73 are electrically coupled to an image signal processor 74, and the image signal processor 74 is provided for receiving a parameter (such as S1 and S0) analyzed by the signal analyzer 72 or a signal source determined by the timing detector 73, so as to determine a signal processing measure such as an underscan and an overscan.

The invention further provides users a way of manually selecting a signal processing measure, wherein the image signal processor 74 is electrically coupled to a select signal processor 75 and an option display unit 76. The option display unit 76 displays the options of different processing measures on a display device through a graphic display interface (not shown in the figure), and the image processing options include an auto detection, an underscan and an overscan. An input of a user's selection is received to generate a select signal for determining the user's desired signal processing measure, and the image signal processor 74 executes the selected scan measure. If the select signal responds to an auto detection option, then the image signal processor 74 will determine a processing measure according to the parameter of the signal analyzer 72.

The image signal processor 74 is electrically coupled to an image signal output unit 77, and the image signal processor 74 integrates the information to determine the final signal processing measure, and finally the image signal output unit 77 outputs the converted image signal by the system 7.

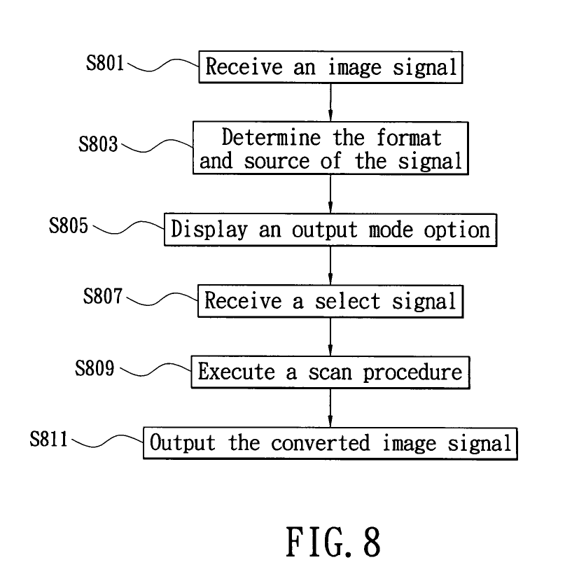

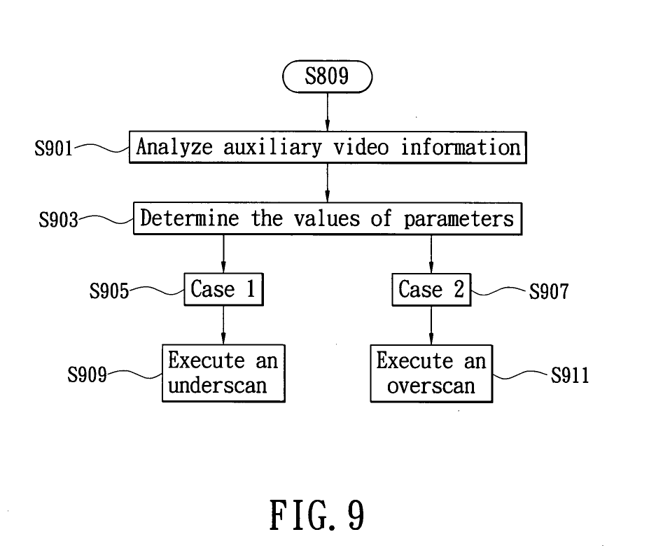

Referring to FIG. 8 for a flow chart of a method for converting digital image signals in accordance with the present invention, the method applies the options as shown in FIG. 4, and users select their desired image processing measure through these options. The procedure starts, and receives an image signal (Step S801), and then determines the format and the source of the image signal based on the detected timing, that is the timing of the image signal (Step S803), and a display device of a converting system as disclosed in a preferred embodiment of the invention displays an input/output mode option (Step S805), and a user determines a desired processing measure, and the options include an auto detection option, an underscan option and an overscan option, and the user can select a control key (including a control panel on a display device or a press key on a remote controller) to generate a select signal, and the system receives the select signal through a wireless (such as Bluetooth, wireless network, infrared) or a cable communication measure. In which the select signal corresponds to the input/output mode options including the aforementioned auto detection option, underscan option and overscan option (Step S807). The scan procedure is executed according to the select signal, and the scan procedure is illustrated in the flow chart as shown in FIG. 9 (Step S809). For instance, the select signal includes an auto detection option, an underscan option and an overscan option. If the auto detection option is selected, the digital image signal converting system will execute a signal processing measure according to the parameters recorded in the information frame of the auxiliary video information (AVI); and finally output the converted image signal (Step S811).

In the scan procedure executed in the Step (S809) of the determination procedure as shown in FIG. 9, if the select signal received by the Step S807 in FIG. 8 is an auto detection option, then the scan procedure in the Step S809 will analyze the auxiliary video information (AVI) carried by the inputted image signal (Step S901), and determine the parameters (Step S903), and a desired scanning measure is selected according to the parameters. The parameter of data byte shall be analyzed to determine the results which include at least two conditions. In condiction 1 as shown in Step (S905), if the parameter S1 is 1 and the parameter S0 is 0, then it means that the received image signal comes from an image playing device that supports the HDMI specification, and an overscan is executed for converting the image signal at the display device (Step S909). In Case 2 as shown in Step (S907), if the parameter S1 is 0 and the parameter S0 is 1, then it means that the received signal is an image signal coming from a computer system, wherein the signal is converted by a DVI-to-HDMI signal converter, and an underscan is executed for converting the image signal at the display device (Step S911).

In another preferred embodiment, users can select the signal processing measure for converting signals. Further, a previous using status can be stored in a memory, so that the system no longer needs to select or detect the desired signal processing measure anymore.

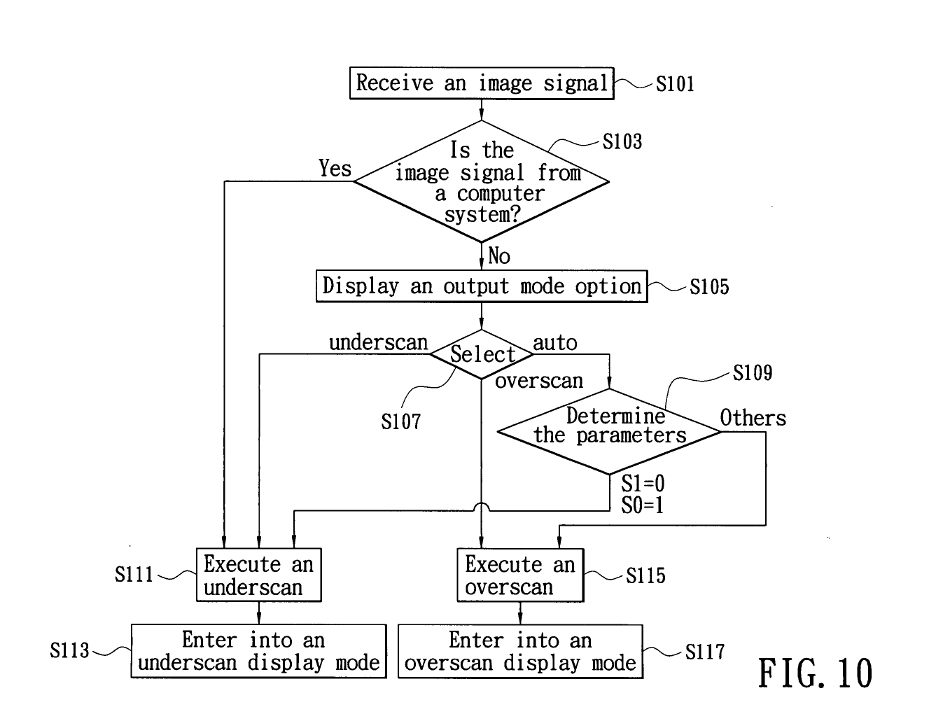

Referring to FIG. 10 for a flow chart of a method for converting digital image signals in accordance with a preferred embodiment of the present invention, the converting system receives an external inputted image signal Step S101), and the timing of the signal is used for determining whether or not the image signal is an image signal of a computer system (Step S103); if yes, which means that the image signal comes from a computer system and is generally converted from DVI to HDMI, then execute an underscan of Step (S111), and enter into an underscan display mode (Step S113); if no, which means that the signal is not from the computer system, and it may be from another audio/video player, then the digital image signal converting system will display the input/output mode options on the display device, such as on a display device by an on-screen display (OSD) technology (Step S105), such that users can select the option from a control panel of a display device or a press key on a remote controller, and the system receives the select signal (Step S107), and each select signal corresponds to an option of the signal processing measure including a specified auto detection, underscan or overscan as follows:

(1) Select an underscan option (Step S111) to execute an undercan to an inputted screen signal, and then enter into an underscan display mode (Step S113);

(2) Select an overscan option (Step S115) to eliminate the masked portion of a cut off portion of a vertical blanking interval (VBI), and then enter into an overscan display mode (Step S117);

(3) Select an auto option to drive the digital image signal converting system to execute an auto detection, and determine a processing measure required for executing an image source according to parameters recorded by an information frame in the auxiliary video information (AVI) carried by the HDMI signal, so that the timing, aspect ratio or scan information of the image signal can be found, and the preferred embodiment references the parameters S1 and S0 in a data byte1 (Step S109), and the following conditions are included:

(4) If the parameters S0=1, S1=0, which means that the inputted image signal should execute an underscan, then the underscan will be executed (Step S111) and the underscan display mode will be entered (Step S113);

(5) For any condition other than the parameters S0=1, S1=0, which means the inputted image signal should execute an overscan (Step S115), then the overscan display mode will be entered (Step S117).

In summation of the description above, the system and method for converting digital image signals disclosed by the invention provides users a way of selecting an image processing measure on a display screen for displaying an image signal coming from a HDMI source or an image signal converted into a HDMI signal by a computer system, so as to solve the problems of having wrong displays caused by wrong scan information.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for converting digital image signals, comprising the steps of:
receiving an image signal;
determining a format and a source of the image signal based on a detected timing;
displaying input/output mode options on a display device;
receiving a select signal, the select signal corresponds to the input/output mode options;
executing a scan procedure based on the select signal; and
outputting the converted image signal.

2. The method for converting digital image signals according to claim 1, wherein the source of the image signal includes a playing device and a computer system that supports High-Definition Multimedia Interface (HDMI).

3. The method for converting digital image signals according to claim 1, wherein the select signal is generated by a control key on a remote controller.

4. The method for converting digital image signals according to claim 1, wherein the select signal indicates an auto detection option, an overscan option, or an underscan option.

5. The method for converting digital image signals according to claim 4, wherein when the select signal indicates the overscan option, then executing the overscan procedure to convert the image signal.

6. The method for converting digital image signals according to claim 4, wherein when the select signal indicates the underscan option, then executing the underscan procedure to convert the image signal.

7. The method for converting digital image signals according to claim 4, wherein when the select signal indicates the auto detection option, analyzing the auxiliary video information (AVI) carried by the image signal, then determine whether to execute the underscan procedure or the overscan procedure based on one or a plurality of parameters included in AVI.

8. The method for converting digital image signals according to claim 7, wherein the AVI is information carried by the HDMI signal.

9. The method for converting digital image signals according to claim 8, wherein the HDMI signal is a signal converted from DVI to HDMI.

10. The method for converting digital image signals according to claim 7, wherein the auxiliary video information (AVI) includes a data byte, wherein the parameter of data byte shall be analyzed to determine the results which comprising the following conditions;
the image signal comes from an image playing device that supports a HDMI specification, in which case executing the overscan procedure to the image signal; and
the image signal comes from an image playing device of a computer system, in which case executing the underscan procedure to the image signal.

11. The method for converting digital image signals according to claim 1, wherein the input/output mode options are displayed on the display device by an on-screen display (OSD) technology.

12. A method for converting digital image signals, comprising the steps of:
receiving an image signal;
determining whether or not the image signal is an image signal of a computer system based on the timing of the image signal;
executing an underscan procedure and entering into an underscan display mode, if the image signal the computer system's image signal;
displaying input/output mode options on a display device, if the image signal is not the computer system's image signal, wherein the options includes an auto detection option, an underscan option and an overscan option;
receiving a select signal corresponding to each input/output mode options;
executing the underscan procedure to the image signal and entering into the underscan display mode if the select signal indicates the underscan option;
executing the overscan procedure to the image signal and entering into the overscan mode if the select signal indicates the overscan option;
determining a processing measure executed by the image signal based on a parameter recorded in the information frame of an auxiliary video information (AVI) carried by a High-Definition Multimedia Interface (HDMI) signal, if the select signal is the auto detection;
entering into the underscan display mode after the underscan is executed, if the parameter indicates that the image signal should execute the underscan procedure; and
entering into the overscan display mode after the overscan procedure is executed, if the parameter indicates that the image signal should execute the overscan procedure.

13. The method for converting digital image signals according to claim 12, wherein the select signal is generated by a control key installed on a remote controller.

14. The method for converting digital image signals according to claim 12, wherein the auxiliary video information (AVI) includes a data byte, wherein the parameter of data byte shall be analyzed to determine the results which comprising the following conditions;
the image signal comes from an image playing device that supports a HDMI specification, in which case executing the overscan procedure to the image signal; and
the image signal comes from an image playing device that supports a HDMI specification, in which case executing the overscan procedure to the image signal.

15. The method for converting digital image signals according to claim 12, wherein the select signal corresponds to a last used state recorded in memory.

16. The method for converting digital image signals according to claim 12, wherein the input/output mode options are displayed on the display device by an on-screen display (OSD) technology.

17. A digital image signal converting system, comprising:
an image signal receiver, for receiving an image signal;
a signal analyzer, electrically coupled to the image signal receiver, for analyzing an auxiliary video information (AVI) carried in a High-Definition Multimedia Interface (HDMI) signal;
a timing detector, electrically coupled to the image signal receiver, for determining the source of the image signal when a timing is received;
an image signal processor, electrically coupled to the signal analyzer and the timing detector, for receiving the message analyzed by the signal analyzer to determine a processing measure; or for receiving the source of the image signal determined by the timing detector to determine a processing measure.
a select signal processor, electrically coupled to the image signal processor, for receiving a select signal;
an option display unit, electrically coupled to the select signal processor, for displaying options on a display device; and
an image signal output unit, electrically coupled to the image signal processor, for outputting the converted image signal.

18. The digital image signal converting system according to claim 17, wherein the options on the display device includes an overscan option, an overscan option, and an underscan option.

19. The digital image signal converting system according to claim 17, wherein the digital image signal includes a HDMI input signal, or a signal of HDMI specification converted from another image signal.

20. The digital image signal converting system according to claim 17, wherein the signal analyzer is for analyzing one or a plurality of parameters recorded in an AVI's information frame.

21. The digital image signal converting system according to claim 20, wherein the parameters are the plurality of parameters in a data byte, which is used for determining the processing measure of the image signal, the parameters of data byte shall be analyzed to determine the results which comprising the following conditions;
the image signal comes from an image playing device that supports a HDMI specification, in which case executing an overscan procedure to the image signal; and
the image signal comes from an image playing device of a computer system, in which case executing an underscan procedure to the image signal.

22. The digital image signal converting system according to claim 17, wherein the select signal is generated by a control key on a remote controller.

23. The digital image signal converting system according to claim 17, wherein the processing measure is executed by the image signal processor and determined according to the select signal which comprises the steps of:
executing the underscan procedure to convert the image signal if the select signal is underscan;
executing the overscan procedure to convert the image signal if the select signal is overscan;
analyzing the AVI carried in the image signal, if the select signal is of auto detection option; and
executing the underscan procedure or the overscan procedure according to one or a plurality of parameters.

24. The digital image signal converting system according to claim 17, wherein the select signal corresponds to a last used state recorded in a memory.
